(19) United States
(12) Patent Application Publication
(10) Pub. No.: US 2026/0210412 A1
(43) Pub. Date: Jul. 23, 2026

(54) FRICTION DISC, MULTIPLATE CLUTCH, TRANSMISSION, AND WORK MACHINE

(71) Applicant: KOMATSU LTD., Tokyo (JP)

(72) Inventor: Kyoshiro KANAMORI, Tokyo (JP)

(21) Appl. No.: 19/144,549

(22) PCT Filed: Nov. 28, 2023
(86) PCT No.: PCT/JP2023/042568

§ 371 Date: Jun. 30, 2025

(30) Foreign Application Priority Data
Feb. 21, 2023 (JP) 2023-025208

(51) Int. Cl. F16D 13/74; F16D 13/64

(52) U.S. Cl. CPC F16D 13/74; F16D 13/648

(57) ABSTRACT

A friction disc includes a lubricating oil groove including a plurality of first and second groove paths. Each first groove path includes a first inlet disposed on an inner peripheral edge side, a first outlet disposed on an outer peripheral edge side, and a first A groove portion formed from the first inlet and inclined to a first circumferential direction side in the circumferential direction relative to a radial direction. Each second groove path includes a second inlet disposed on the inner peripheral edge side, is inclined to a second circumferential direction side opposite to the first circumferential direction relative to the radial direction, and joins the first A groove portion. A joining portion where the second groove path joins the first A groove portion forms a three-way junction, and is disposed closer to the first inlet between the first inlet and the first outlet of the first groove path.

### TECHNICAL FIELD

The present invention relates to a friction disc, a multiplate clutch, a transmission, and a work machine.

### BACKGROUND ART

In a transmission including a planetary gear mechanism, a multiplate clutch is used. The multiplate clutch includes a plurality of friction discs and a plurality of separator plates, and performs shifting by controlling rotational movement by engaging or disengaging the friction discs and the separator plates.

In such a multiplate clutch, the friction disc and the separator plate move relative to each other at the time of disengagement, so that drag torque is generated by viscosity of lubricating oil. A groove for discharging oil to the friction disc is formed in order to reduce the drag torque (see, for example, Patent Literature 1).

### CITATION LIST

### Patent Literature

Patent Literature 1: JP 2018-119646 A

### SUMMARY OF INVENTION

However, further reduction of a power transmission loss is required, and reduction of the drag torque is insufficient in the structure disclosed in Patent Literature 1.

An object of the present disclosure is to provide a friction disc, a multiplate clutch, a transmission, and a work machine capable of further reducing drag torque.

### Solution to Problem

A friction disc according to a first aspect of the present disclosure is a friction disc used in a power transmission device, and includes a lubricating oil groove through which lubricating oil passes. The lubricating oil groove includes a plurality of first groove paths and a plurality of second groove paths. The plurality of first groove paths is formed in a surface side by side in a circumferential direction. The plurality of second groove paths is formed in the surface side by side in the circumferential direction. Each of the first groove paths has a first inlet, a second outlet, and a first A groove portion. The first inlet is disposed on an inner peripheral edge side, and into which the lubricating oil flows. The first outlet is disposed on an outer peripheral edge side, and from which the lubricating oil flows out. The first A groove portion is formed from the first inlet and is inclined to a first circumferential direction side in the circumferential direction with respect to a radial direction. Each of the second groove paths includes a second inlet disposed on the inner peripheral edge side, and into which the lubricating oil flows, is inclined to a second circumferential direction side opposite to the first circumferential direction with respect to the radial direction, and joins the first A groove portion. A joining portion where the second groove path joins the first A groove portion forms a three-way junction, and is disposed closer to the first inlet between the first inlet and the first outlet of the first groove path.

A friction disc according to a second aspect of the present disclosure is a friction disc used in a power transmission device, and includes a lubricating oil groove through which lubricating oil passes. The lubricating oil groove includes a plurality of third groove paths and a plurality of fourth groove paths. The plurality of third groove paths is formed in a surface side by side in a circumferential direction. The plurality of fourth groove paths is formed in the surface side by side in the circumferential direction. Each of the third groove paths has a third inlet, a second outlet, and a third A groove portion. The third inlet is disposed on an inner peripheral edge side, and into which the lubricating oil flows. The second outlet is disposed on an outer peripheral edge side, and from which the lubricating oil flows out. The third A groove portion is formed from the third inlet and is inclined to a second circumferential direction side in the circumferential direction with respect to a radial direction. Each of the fourth groove paths branches from the third A groove portion and is inclined to a first circumferential direction side opposite to the second circumferential direction with respect to the radial direction. A branching portion where the fourth groove path branches from the third A groove portion forms a three-way junction, and is disposed closer to the third inlet between the third inlet and the second outlet of the third groove path.

### Advantageous Effects of Invention

According to the present disclosure, it is possible to provide a friction disc, a multiplate clutch, a transmission, and a work machine capable of further reducing drag torque.

### BRIEF DESCRIPTION OF DRAWINGS

FIG. 1 is a perspective view illustrating a bulldozer according to an embodiment of the present disclosure.

FIG. 2 is a view illustrating a configuration of a power transmission device of the bulldozer according to the embodiment of the present disclosure.

FIG. 3 is a view illustrating a configuration of a transmission of the bulldozer according to the embodiment of the present disclosure.

FIG. 4 is a partial perspective view of a reverse clutch of the bulldozer according to the embodiment of the present disclosure.

FIG. 5 is an exploded perspective view of FIG. 4.

FIG. 6A is a perspective view of a friction disc according to the embodiment of the present disclosure.

FIG. 6B is a partially enlarged perspective view of the friction disc according to the embodiment of the present disclosure.

FIG. 7A is a plan view of the friction disc according to the embodiment of the present disclosure.

FIG. 7B is a partially enlarged plan view of the friction disc according to the embodiment of the present disclosure.

FIG. 7C is a schematic view illustrating the friction disc according to the embodiment of the present disclosure with an inner circumference, an outer circumference, a curve, and an inner peripheral edge.

FIG. 7D is a plan view illustrating a flow of lubricating oil when the friction disc according to the embodiment of the present disclosure is rotated in a first circumferential direction.

FIG. 7E is a plan view illustrating a flow of lubricating oil when the friction disc according to the embodiment of the present disclosure is rotated in a second circumferential direction.

FIG. 8(a) is an enlarged plan view illustrating a friction disc of Comparative Example 1. FIG. 8(b) is an enlarged plan view illustrating a friction disc of Comparative Example 2. FIG. 8(c) is an enlarged plan view illustrating a friction disc of Comparative Example 3.

FIG. 9 is a graph illustrating a change in drag torque with respect to a rotational speed in Example and Comparative Examples 1 to 3.

### DESCRIPTION OF EMBODIMENTS

A friction disc, a multiplate clutch, a transmission, and a work machine according to an embodiment of the present disclosure will be described with reference to the drawings. The friction disc of the present embodiment is used in, for example, a drive system of a work machine.

### Configuration

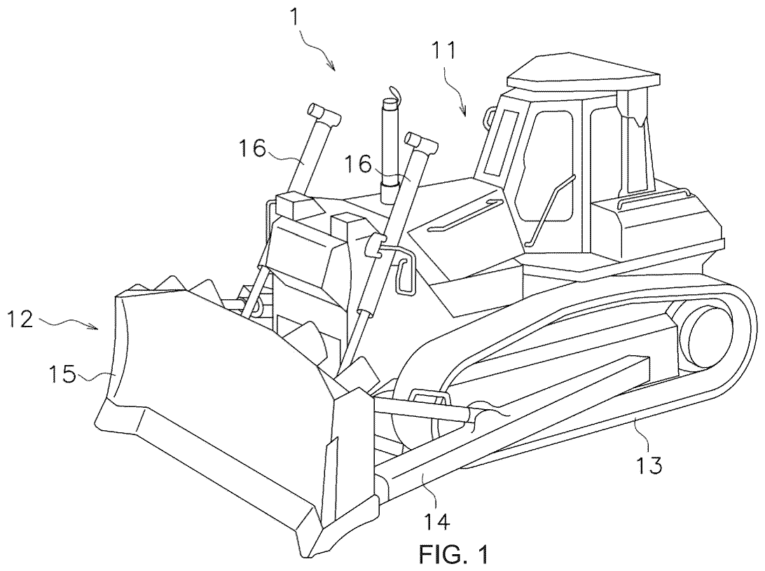

FIG. 1 is a perspective view of a bulldozer 1 that is an example of a work machine of the present disclosure. The bulldozer 1 includes a vehicle body 11 and an implement 12. The vehicle body 11 includes a crawler belt 13. When power from an engine is transmitted and the crawler belt 13 rotates, the bulldozer 1 travels.

The implement 12 is attached to the vehicle body 11. The implement 12 includes a lift frame 14, a blade 15, and a lift cylinder 16. The lift frame 14 is attached to the vehicle body 11 so as to be movable up and down. The lift frame 14 supports the blade 15. The blade 15 moves up and down along with the operation of the lift frame 14. The lift cylinder 16 is connected to the vehicle body 11 and the lift frame 14. When the lift cylinder 16 extends and contracts, the lift frame 14 moves up and down.

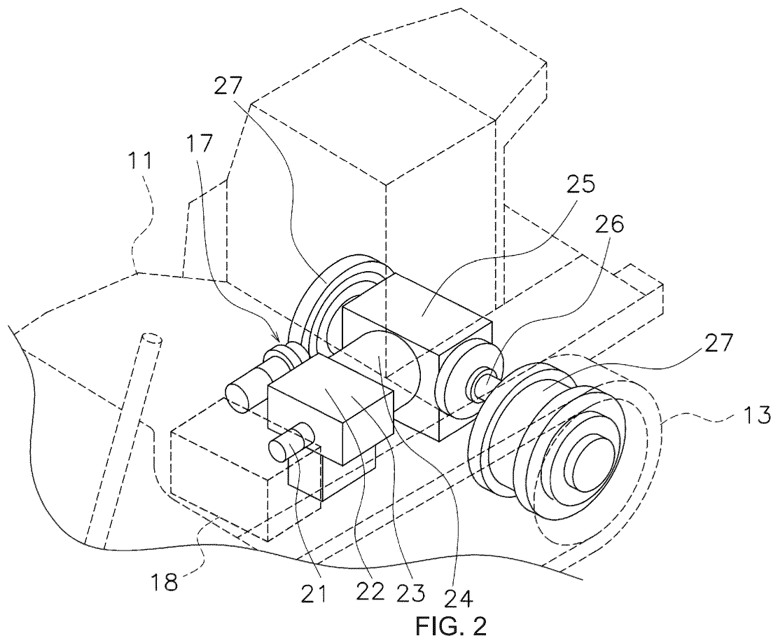

FIG. 2 is a schematic view for describing a configuration of a power transmission device 17 of the bulldozer 1. The bulldozer 1 includes the power transmission device 17. The power transmission device 17 transmits power from an engine 18 to the crawler belt 13.

The power transmission device 17 includes a universal joint 21, a torque converter 22, a power take off 23, a transmission 24, a hydrostatic steering system (HSS) 25, a horizontal axis 26, and a final drive 27.

The universal joint 21 transmits the power from the engine 18 to the torque converter 22. The universal joint 21 outputs the power from the engine 18 to the power take off 23. The power take off 23 outputs the power from the engine 18 to a hydraulic oil pump that supplies hydraulic oil to the lift cylinder 16.

The torque converter 22 outputs the power of the engine 18 input via the universal joint 21 to the transmission 24. The transmission 24 changes a transmission gear ratio in switching between forward movement and backward movement, or in a state of the forward movement or the backward movement, of the vehicle body 11. The HSS 25 includes a steering pump, a steering motor, a steering planetary mechanism, and the like, and turns linear power from the transmission 24 and turning power from a hydraulic motor by giving a difference between left and right output rotations by a differential mechanism of a planetary gear train. The horizontal axis 26 transmits the power from the HSS 25 to the final drive 27. The final drive 27 is disposed on the left and right, and is wound with the crawler belt 13. The rotation of the final drive 27 rotates the crawler belt 13, and the vehicle body 11 travels.

### Transmission 24

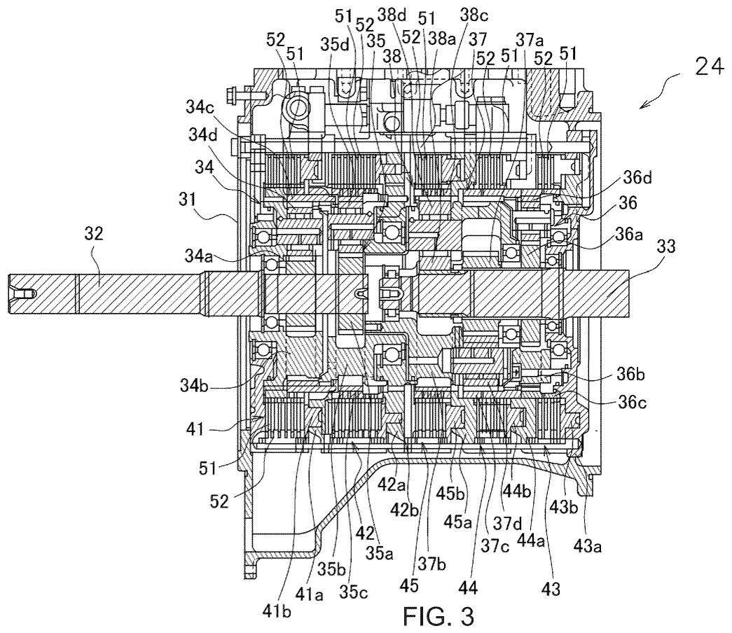

FIG. 3 is a view illustrating a configuration of the transmission 24. The transmission 24 includes a case 31, an input shaft 32, an output shaft 33, a reverse planetary gear mechanism 34, a forward planetary gear mechanism 35, a first speed planetary gear mechanism 36, a second speed planetary gear mechanism 37, a third speed planetary gear mechanism 38, a reverse clutch 41, a forward clutch 42, a first speed clutch 43, a second speed clutch 44, and a third speed clutch 45.

The input shaft 32 transmits the power from the torque converter 22. The input shaft 32 is rotatably supported by the case 31. The output shaft 33 transmits output subjected to control of a rotational direction and the transmission gear ratio to the HSS 25. The output shaft 33 is disposed coaxially with the input shaft 32.

The reverse planetary gear mechanism 34 is disposed around the input shaft 32. The reverse planetary gear mechanism 34 is disposed on a most upstream side in a power transmission direction. The reverse planetary gear mechanism 34 includes a reverse sun gear 34a, a reverse carrier 34b, a reverse ring gear 34c, and a plurality of reverse planetary gears 34d. The reverse sun gear 34a is fixed to the input shaft 32.

The reverse carrier 34b rotatably supports the plurality of reverse planetary gears 34d disposed at substantially equal intervals in a circumferential direction. Each of the plurality of reverse planetary gears 34d meshes with the reverse sun gear 34a. The reverse ring gear 34c is disposed on an outer peripheral side of the plurality of reverse planetary gears 34d pivotally supported by the reverse carrier 34b, and meshes with the plurality of reverse planetary gears 34d.

The forward planetary gear mechanism 35 is disposed around the input shaft 32. The forward planetary gear mechanism 35 is disposed downstream of the reverse planetary gear mechanism 34 in the power transmission direction. The forward planetary gear mechanism 35 includes a forward sun gear 35a, a forward carrier 35b, a forward ring gear 35c, and a plurality of forward planetary gears 35d. The forward sun gear 35a is fixed to the input shaft 32. The forward carrier 35b rotatably supports the plurality of forward planetary gears 35d disposed at substantially equal intervals in the circumferential direction. Each of the plurality of forward planetary gears 35d meshes with the forward sun gear 35a. The forward ring gear 35c is disposed on an outer peripheral side of the plurality of forward planetary gears 35d pivotally supported by the forward carrier 35b, and meshes with the plurality of forward planetary gears 35d.

The first speed planetary gear mechanism 36 is disposed around the output shaft 33. The first speed planetary gear mechanism 36 is disposed on a most downstream side of the output shaft 33 in the power transmission direction. The first speed planetary gear mechanism 36 includes a first speed sun gear 36a, a first speed carrier 36b, a first speed ring gear 36c, and a plurality of first speed planetary gears 36d. The first speed sun gear 36a is fixed to the output shaft 33. The first speed carrier 36b rotatably supports the plurality of first speed planetary gears 36d disposed at substantially equal intervals in the circumferential direction. Each of the plurality of first speed planetary gears 36d meshes with the first speed sun gear 36a. The first speed ring gear 36c is disposed on an outer peripheral side of the plurality of first speed planetary gears 36d pivotally supported by the first speed carrier 36b, and meshes with the plurality of first speed planetary gears 36d.

The second speed planetary gear mechanism 37 is disposed around the output shaft 33. The second speed planetary gear mechanism 37 is disposed upstream of the first speed planetary gear mechanism 36 in the power transmission direction. The second speed planetary gear mechanism 37 includes a second speed sun gear 37a, a second/third speed carrier 37b, a second speed ring gear 37c, and a plurality of second speed planetary gears 37d. The second speed sun gear 37a is fixed to the output shaft 33. The second/third speed carrier 37b rotatably supports the plurality of second speed planetary gears 37d disposed at substantially equal intervals in the circumferential direction. Each of the plurality of second speed planetary gears 37d meshes with the second speed sun gear 37a. The second speed ring gear 37c is disposed on an outer peripheral side of the plurality of second speed planetary gears 37d pivotally supported by the second/third speed carrier 37b, and meshes with the plurality of second speed planetary gears 37d.

The third speed planetary gear mechanism 38 is disposed around the output shaft 33. The third speed planetary gear mechanism 38 is disposed upstream of the second speed planetary gear mechanism 37 in the power transmission direction. The third speed planetary gear mechanism 38 includes a third speed sun gear 38a, a second/third speed carrier 37b, a third speed ring gear 38c, and a plurality of third speed planetary gears 38d. The third speed sun gear 38a is fixed to the output shaft 33. The second/third speed carrier 37b rotatably supports the plurality of third speed planetary gears 38d disposed at substantially equal intervals in the circumferential direction.

The second/third speed carrier 37b also serves as a planetary carrier for both the second speed planetary gear mechanism 37 and the third speed planetary gear mechanism 38.

Each of the plurality of third speed planetary gears 38d meshes with the third speed sun gear 38a. The third speed ring gear 38c is disposed on an outer peripheral side of the plurality of third speed planetary gears 38d pivotally supported by the second/third speed carriers 37b, and meshes with the plurality of third speed planetary gear 38d.

Note that the reverse planetary gear mechanism 34, the forward planetary gear mechanism 35, the first speed planetary gear mechanism 36, the second speed planetary gear mechanism 37, or the third speed planetary gear mechanism 38 correspond to an example of a power transmission mechanism.

The reverse clutch 41 is disposed on an outer peripheral side of the reverse planetary gear mechanism 34. The reverse clutch 41 fixes or unfixes the reverse carrier 34b to or from the case 31. By fixing the reverse carrier 34b to the case 31, for example, the output shaft 33 can be rotated in an opposite direction with respect to the input shaft 32 to reverse the bulldozer 1.

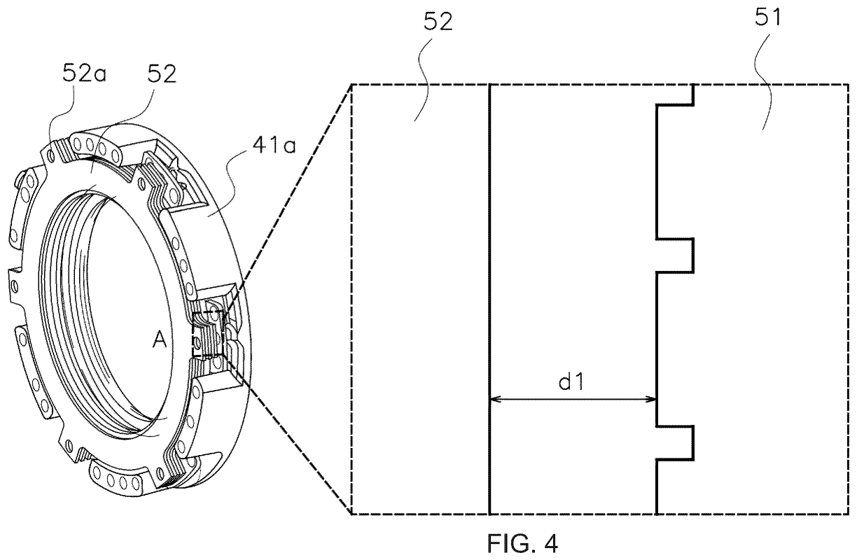

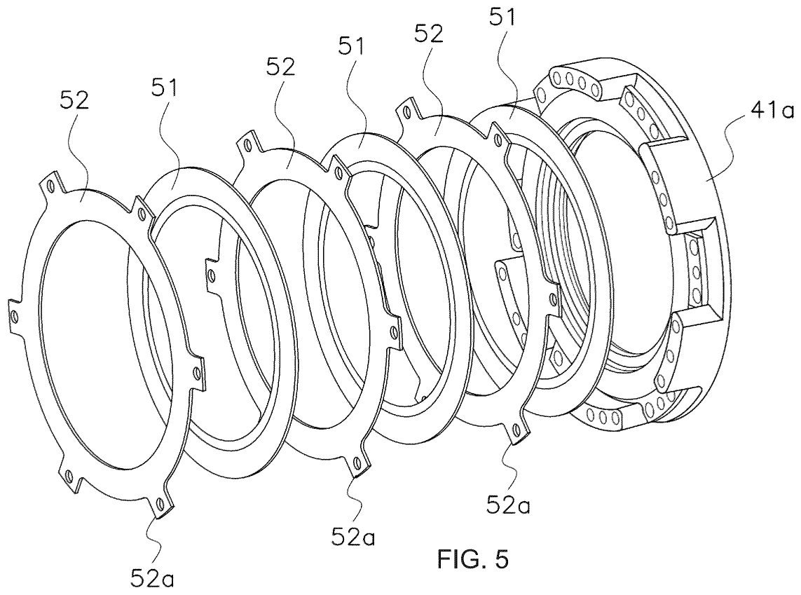

The reverse clutch 41 includes a plurality of friction discs 51, a plurality of separator plates 52, a reverse clutch housing 41a, and a piston 41b. FIG. 4 is a partial perspective view of the reverse clutch 41. FIG. 5 is an exploded perspective view of FIG. 4. FIGS. 4 and 5 illustrate a part of the reverse clutch housing 41a.

As illustrated in FIG. 5, the friction disc 51 has an annular shape. The friction disc 51 is rotatably disposed. The separator plate 52 has an annular shape.

The separator plate 52 has protrusions 52a on its outer periphery, and is fixed to the case 31. The friction disc 51 rotates together with the reverse carrier 34b. The friction discs 51 and the separator plates 52 are alternately disposed along an axial direction of the input shaft 32.

The reverse clutch housing 41a houses the plurality of friction discs 51 and the plurality of separator plates 52. The piston 41b presses the separator plate 52 and the friction disc 51 against the reverse clutch housing 41a along the axial direction of the input shaft 32. In a state where the friction disc 51 is not pressed by the piston 41b, as illustrated in the enlarged view of the part A of FIG. 4, a gap dl is provided between the separator plate 52 and the friction disc 51, and the friction disc 51 is rotatable together with the reverse carrier 34b. The configuration of the friction disc 51 will be described in detail below. When the piston 41b is driven by hydraulic pressure and the separator plate 52 and the friction disc 51 are pressed against the reverse clutch housing 41a, the friction disc 51 comes into contact with the separator plate 52, so that the friction disc 51 cannot rotate. As a result, the reverse carrier 34b cannot rotate, and the reverse carrier 34b can be fixed to the case 31. Note that a pin penetrates a hole formed in the protrusion 52a of the separator plate 52, and a return spring is provided on the pin between adjacent separator plates 52. Due to a biasing force of the return spring, the separator plate 52 is spaced when the piston 41b is released, and the friction disc 51 can idle.

The forward clutch 42 is disposed on an outer peripheral side of the forward planetary gear mechanism 35. The forward clutch 42 fixes or unfixes the forward ring gear 35c to or from the case 31. By fixing the forward ring gear 35c to the case 31, for example, the output shaft 33 can be rotated in the same direction with respect to the input shaft 32 to forward the bulldozer 1. Similarly to the reverse clutch 41, the forward clutch 42 includes a plurality of the friction discs 51, a plurality of the separator plates 52, a forward clutch housing 42a, and a piston 42b. The forward clutch 42 has a configuration similar to the reverse clutch 41 although the number of friction discs 51 and the number of separator plates 52 are different, and thus description of the forward clutch housing 42a and the piston 42b is omitted.

The first speed clutch 43 is disposed on an outer peripheral side of the first speed planetary gear mechanism 36. The first speed clutch 43 fixes or unfixes the first speed ring gear 36c to or from the case 31. By fixing the first speed ring gear 36c to the case 31, the output shaft 33 can be rotated with respect to the input shaft 32 at the first speed transmission gear ratio to forward or reverse the bulldozer 1. Similarly to the reverse clutch 41, the first speed clutch 43 includes a plurality of the friction discs 51, a plurality of the separator plates 52, a first speed clutch housing 43a, and a piston 43b. The first speed clutch 43 is different from the reverse clutch 41 in the number of friction discs 51 and the number of separator plates 52. The configurations of the first speed clutch housing 43a and the piston 43b are similar to those of the reverse clutch 41, and thus description thereof is omitted.

The second speed clutch 44 is disposed on an outer peripheral side of the second speed planetary gear mechanism 37. The second speed clutch 44 fixes or unfixes the second speed ring gear 37c to or from the case 31. By fixing the second speed ring gear 37c to the case 31, the output shaft 33 can be rotated with respect to the input shaft 32 at the second speed transmission gear ratio to forward or reverse the bulldozer 1. The second speed clutch 44 includes a plurality of the friction discs 51, a plurality of the separator plates 52, a second speed clutch housing 44a, and a piston 44b. The second speed clutch 44 has a configuration similar to the first speed clutch 43 although the number of friction discs 51 and the number of separator plates 52 are different, and thus description of the second speed clutch housing 44a and the piston 44b is omitted.

The third speed clutch 45 is disposed on an outer peripheral side of the third speed planetary gear mechanism 38. The third speed clutch 45 fixes or unfixes the third speed ring gear 38c to or from the case 31. By fixing the third speed ring gear 38c to the case 31, the output shaft 33 can be rotated with respect to the input shaft 32 at the third speed transmission gear ratio to forward or reverse the bulldozer 1. The third speed clutch 45 includes a plurality of the friction discs 51, a plurality of the separator plates 52, a third speed clutch housing 45a, and a piston 45b. The third speed clutch 45 has a configuration similar to the first speed clutch 43 although the number of friction discs 51 and the number of separator plates 52 are different, and thus description of the third speed clutch housing 45a and the piston 45b is omitted. The reverse clutch 41, the forward clutch 42, the first speed clutch 43, the second speed clutch 44, and the third speed clutch 45 correspond to an example of a multiplate clutch.

As described above, the transmission 24 of the present embodiment is a three-stage forward and three-stage reverse transmission having five sets of the planetary gear mechanisms and the clutches. One rotational direction and one rotational speed can be selected by fixing two clutches of the five sets of planetary gear mechanisms and clutches to the case 31 by hydraulic pressure. Note that when the piston 41b of the reverse clutch 41 is driven as described above, the reverse carrier 34b is fixed to the case 31, and the power is output from the reverse ring gear 34c. As a result, the rotational direction of the output is opposite to the input. In the clutches 42, 43, 44, and 45 other than the reverse clutch 41, when the piston is driven, each ring gear is fixed to the case 31, and the power is output from the carrier, so that the rotational directions of the output and the input become the same.

For example, by setting the reverse clutch 41 to a fixed state and setting the first speed clutch 43 to a fixed state, traveling can be set to a reverse one stage. In this case, since the reverse ring gear 34c, the forward carrier 35b, and the second/third speed carrier 37b are coupled, the output from the reverse ring gear 34c is transmitted to the second/third speed carrier 37b. Rotation of the second/third speed carrier 37b is transmitted to the second speed ring gear 37c via the second speed planetary gear 37d, and the first speed carrier 36b coupled to the second speed ring gear 37c rotates. Since the first speed ring gear 36c is fixed to the case 31 by the first speed clutch 43, the first speed sun gear 36a rotates via the first speed planetary gear 36d by the rotation of the first speed carrier 36b, and the output shaft 33 to which the first speed sun gear 36a is fixed rotates.

Note that the friction disc 51 of the reverse clutch 41 rotates only in one direction. The friction disc 51 of the forward clutch 42 rotates only in one direction. The friction discs 51 of the first speed clutch 43, the second speed clutch 44, and the third speed clutch 45 rotate in both directions.

### Friction Disc 51

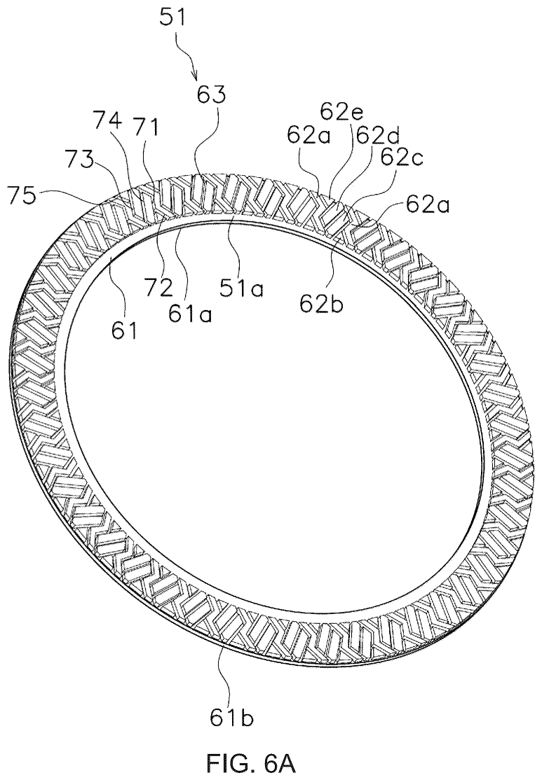

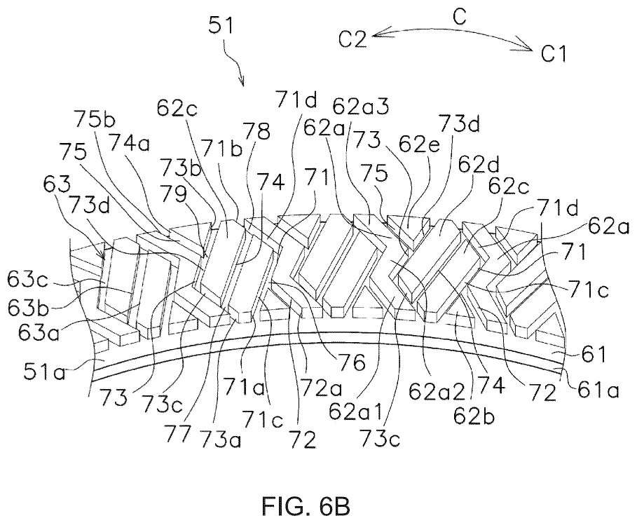

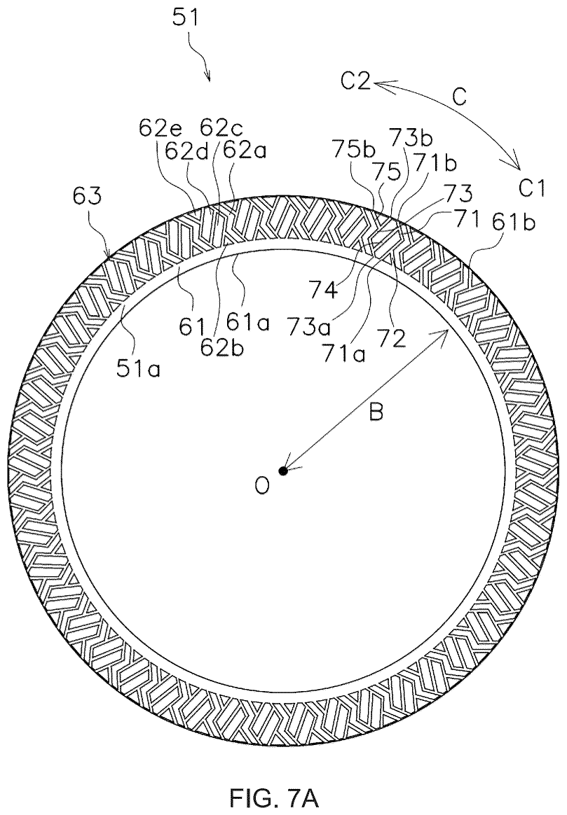

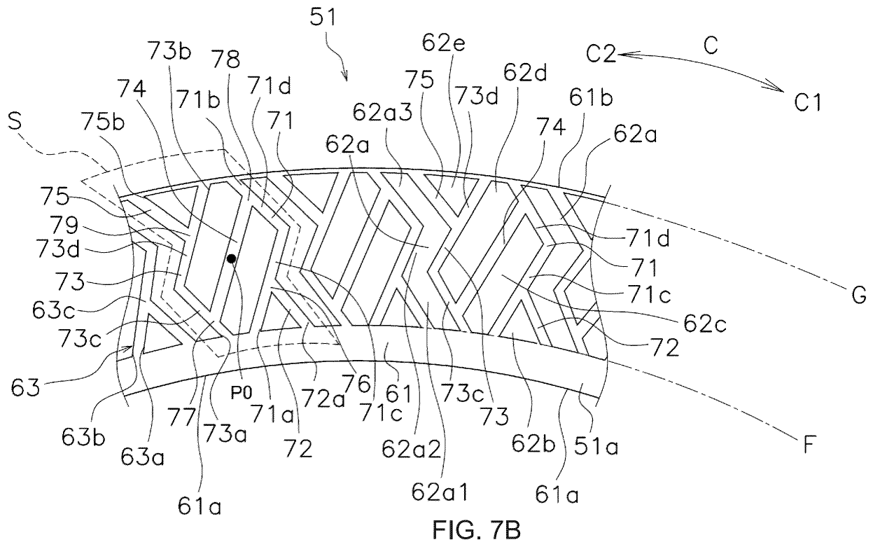

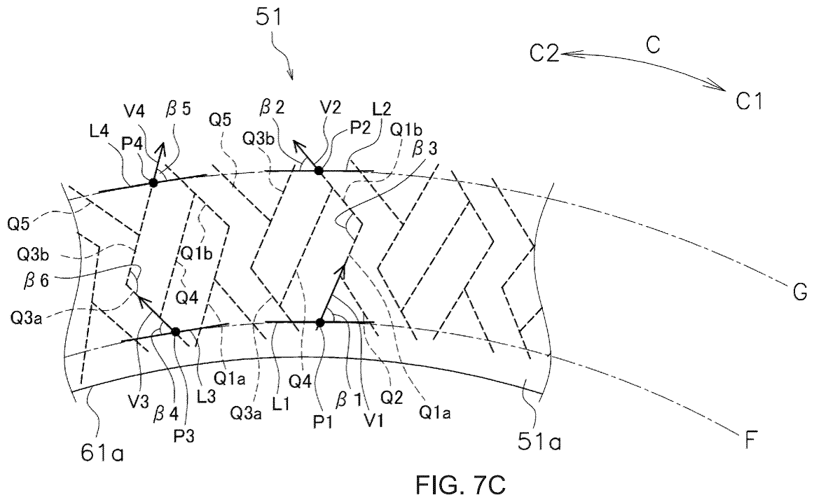

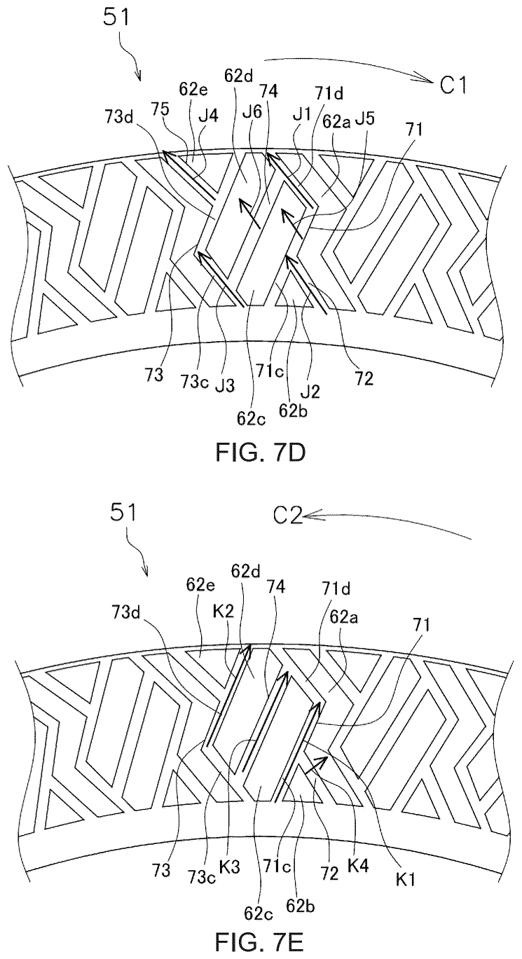

FIG. 6A is a perspective view of the friction disc 51. FIG. 6B is a partially enlarged perspective view of the friction disc 51. FIG. 7A is a front view of the friction disc 51. FIG. 7B is a partially enlarged front view of the friction disc 51.

As illustrated in FIGS. 6A and 6B, the friction disc 51 includes a plate member 61, a plurality of friction portions 62a, 62b, 62c, 62d, and 62e, and a lubricating oil groove 63. The plate member 61 has an annular shape, and the plate member 61 has an inner peripheral edge 61a and an outer peripheral edge 61b. The plate member 61 is made of metal. As illustrated in FIG. 7A, a direction along the circumference of the friction disc 51 is indicated as a circumferential direction C, and a direction toward or away from a center is indicated as a radial direction B. Further, one direction of the circumferential direction C is indicated by a first circumferential direction C1, and the opposite direction of the first circumferential direction C1 is indicated by a second circumferential direction C2. The center of the friction disc 51 is indicated by O.

The plurality of friction portions 62a, 62b, 62c, 62d, and 62e is similarly disposed on both surfaces of the plate member 61. The lubricating oil groove 63 is formed between the friction portions 62a, 62b, 62c, 62d, and 62e. After the friction material is attached to a surface of the plate member 61, the portion of the lubricating oil groove 63 is incinerated by laser processing, so that the plurality of friction portions 62a, 62b, 62c, 62d, and 62e is also formed together with the lubricating oil groove 63.

The plurality of friction portions 62a, 62b, 62c, 62d, and 62e is disposed over the entire circumference in an annular shape. The plurality of friction portions 62a, 62b, 62c, 62d, and 62e is disposed between an outer circumference G and an inner circumference F in FIG. 7B.

The plurality of friction portions 62a, 62b, 62c, 62d, and 62e abuts on the separator plate 52 when the friction disc 51 and the separator plate 52 are pressed against each other (the clutch is in an ON state). As a friction material forming the friction portions 62a, 62b, 62c, 62d, and 62e, for example, a carbon paper material, a resin molding material, a sintered metal, or the like can be used.

The friction portion 62a is formed to be bent from the inner circumference F to the outer circumference G in front view. As illustrated in FIGS. 6B and 7B, the friction portion 62a includes a first portion 62a1, a second portion 62a2, and a third portion 62a3. The first portion 62al is inclined from the inner peripheral edge 61a side to the second circumferential direction C2 side with respect to the radial direction B and extends toward the outer peripheral edge 61b side. The second portion 62a2 is inclined from an end of the first portion 62al on the outer peripheral edge 61b side to the first circumferential direction C1 side with respect to the radial direction B and extends toward the outer peripheral edge 61b side. The third portion 62a3 is inclined from an end of the second portion 62a2 on the outer peripheral edge 61b side to the second circumferential direction C2 side with respect to the radial direction B and extends to the outer circumference G.

The friction portion 62b has a substantially triangular shape in front view. The friction portion 62b is disposed along the inner circumference F. The friction portion 62b is disposed on the second circumferential direction C2 side of the first portion 62al of the friction portion 62a with a predetermined space from the first portion 62a1.

The friction portion 62c has a substantially parallelogram shape in front view. An end of the friction portion 62c on the inner circumference F side is cut along the inner circumference F. The friction portion 62c is disposed on the second circumferential direction C2 side of the friction portion 62a and the friction portion 62b with a predetermined space from the friction portion 62a and the friction portion 62b.

The friction portion 62d has a substantially parallelogram shape in front view. An end of the friction portion 62d on the outer circumference G side is cut along the outer circumference G. The friction portion 62d is disposed on the second circumferential direction C2 side of the friction portion 62a and the friction portion 62c with a predetermined space from the friction portion 62a and the friction portion 62c.

The friction portion 62e has a substantially triangular shape in front view. The friction portion 62e is disposed along the outer circumference G. The friction portion 62e is disposed on the second circumferential direction C2 side of the friction portion 62d with a space from the friction portion 62d.

The lubricating oil groove 63 is formed by the interval between the friction portions 62a, 62b, 62c, 62d, and 62e described above. Lubricating oil passes through the lubricating oil groove 63. The lubricating oil flows through the lubricating oil groove 63 from the inner peripheral edge 61a side toward the outer peripheral edge 61b side. The lubricating oil is supplied from, for example, the input shaft 32 or the like. The lubricating oil groove 63 has a side wall 63a, a side wall 63b, and a bottom surface 63c. The side wall 63a is disposed on the first circumferential direction C1 side. The side wall 63b is disposed on the second circumferential direction C2 side. The bottom surface 63c is the surface of the plate member 61.

As illustrated in FIGS. 6B and 6C, the lubricating oil groove 63 includes a plurality of first groove paths 71, a plurality of second groove paths 72, a plurality of third groove paths 73, a plurality of fourth groove paths 74, and a plurality of fifth groove paths 75. With the first groove path 71, the second groove path 72, the third groove path 73, the fourth groove path 74, and the fifth groove path 75 as one set S (surrounded by the dotted line in FIG. 7B), a plurality of the sets is disposed side by side over the entire circumference in the circumferential direction C.

The plurality of first groove paths 71 is disposed in a surface 51a of the friction disc 51 side by side in the circumferential direction C. As illustrated in FIG. 7B, the first groove path 71 includes a first inlet 71a, a first outlet 71b, a first A groove portion 71c, and a first B groove portion 71d. The lubricating oil flows into the first inlet 71a. The first inlet 71a opens to the inner peripheral edge 61a side. The lubricating oil flows out of the first outlet 71b. The first outlet 71b opens to the outer peripheral edge 61b side.

The first A groove portion 71c is formed from the first inlet 71a toward the outer peripheral edge 61b side. The first A groove portion 71c is inclined to the first circumferential direction C1 side with respect to the radial direction B. The first A groove portion 71c is formed between the friction portion 62b and the friction portion 62c and between the friction portion 62c and the friction portion 62a. The first B groove portion 71d is formed from an end of the first A groove portion 71c on the outer peripheral edge 61b side to the first outlet 71b toward the outer peripheral edge 61b. The first B groove portion 71d is inclined on the second circumferential direction C2 side with respect to the radial direction B. The first B groove portion 71d is formed between the friction portion 62a and the friction portion 62d and between the friction portion 62a and the friction portion 62c.

The plurality of second groove paths 72 is disposed in the surface 51a of the friction disc 51 side by side in the circumferential direction C. The second groove path 72 has a second inlet 72a. The lubricating oil flows into the second inlet 72a. The second inlet 72a opens to the inner peripheral edge 61a side. The second inlet 72a is disposed on the first circumferential direction C1 side of the first inlet 71a. The second groove path 72 extends from the second inlet 72a toward the outer peripheral edge 61b side. The second groove path 72 is provided to be inclined to the second circumferential direction C2 side with respect to the radial direction B. The second groove path 72 joins the first A groove portion 71c of the first groove path 71 at a joining portion 76. The joining portion 76 forms a three-way junction. The joining portion 76 is disposed closer to the first inlet 71a between the first inlet 71a and the first outlet 71b of the first groove path 71.

The plurality of third groove paths 73 is disposed in the surface 51a of the friction disc 51 side by side in the circumferential direction C. The third groove path 73 includes a third inlet 73a, a second outlet 73b, a third A groove portion 73c, and a third B groove portion 73d. The lubricating oil flows into the third inlet 73a. The third inlet 73a opens to the inner peripheral edge 61a side. The lubricating oil flows out from the second outlet 73b. The second outlet 73b opens to the outer peripheral edge 61b side. The third A groove portion 73c is formed from the third inlet 73a toward the outer peripheral edge 61b side. The third A groove portion 73c is inclined to the second circumferential direction C2 side with respect to the radial direction B. The third A groove portion 73c is formed between the friction portion 62a and the friction portion 62c and between the friction portion 62a and the friction portion 62d. The third B groove portion 73d is formed from an end of the third A groove portion 73c on the outer peripheral edge 61b side to the second outlet 73b toward the outer peripheral edge 61b. The third B groove portion 73d is inclined to the first circumferential direction C1 side with respect to the radial direction B. The third B groove portion 73d is formed between the friction portion 62a and the friction portion 62d and between the friction portion 62d and the friction portion 62e.

The plurality of fourth groove paths 74 is disposed in the surface 51a of the friction disc 51 side by side in the circumferential direction C. The fourth groove path 74 branches from the third A groove portion 73c at a branching portion 77, is formed toward the outer peripheral edge 61b side, and joins the first B groove portion 71d at a joining portion 78. The fourth groove path 74 is inclined to the first circumferential direction C1 side with respect to the radial direction B. The branching portion 77 forms a three-way junction. The joining portion 78 forms a three-way junction. The branching portion 77 is disposed closer to the third inlet 73a between the third inlet 73a and the second outlet 73b of the third groove path 73. The joining portion 78 is disposed closer to the first outlet 71b between the first inlet 71a and the first outlet 71b of the first groove path 71.

The plurality of fifth groove paths 75 is disposed in the surface 51a of the friction disc 51 side by side in the circumferential direction C. The fifth groove path 75 has a third outlet 75b, and the third outlet 75b is disposed on the second circumferential direction C2 side with respect to the second outlet 73b. The fifth groove path 75 branches from the third B groove portion 73d at a branching portion 79, extends toward the outer peripheral edge 61b side, and is formed up to the third outlet 75b. The fifth groove path 75 is inclined from the branching portion 79 toward the second circumferential direction C2 side with respect to the radial direction B. The fifth groove path 75 is formed between the third portion 62a3 of the friction portion 62a and the friction portion 62e. The branching portion 79 forms a three-way junction. The branching portion 79 is disposed closer to the second outlet 73b between the third inlet 73a and the second outlet 73b of the third groove path 73.

The first inlet 71a, the second inlet 72a, and the third inlet 73a are disposed on the inner circumference F centered on a center O of the friction disc 51. The inner circumference F is disposed on the outer peripheral edge 61b side with respect to the inner peripheral edge 61a. Further, the first outlet 71b, the second outlet 73b, and the third outlet 75b are disposed on the outer circumference G centered on the center O of the friction disc 51. The joining portion 76 is disposed closer to the inner circumference F than to the outer circumference G. The branching portion 77 is disposed closer to the inner circumference F than to the outer circumference G. The joining portion 78 is disposed closer to the outer circumference G than to the inner circumference F. The branching portion 79 is disposed closer to the outer circumference G than to the inner circumference F.

The side wall 63a and the side wall 63b are not provided with unevenness serving as an oil reservoir except for the joining portions 76 and 78 and the branching portions 77 and 79. In the present embodiment, the side wall 63a and the side wall 63b are formed linearly in front view except for the joining portions 76 and 78 and the branching portions 77 and 79.

A width of the first groove path 71 is substantially constant. From the viewpoint of frictional force and coolability, a length of the width of the first groove path 71 is preferably 0.3% or more and 1.2% or less of a radius of the friction disc 51. The width of the third groove path 73 is substantially constant. From the viewpoint of frictional force and coolability, the length of the width of the third groove path 73 is preferably 0.3% or more and 1.2% or less of a radius of the friction disc 51.

In the present embodiment, the width between the side wall 63a and the side wall 63b of the lubricating oil groove 63 is formed to be substantially constant. In the present embodiment, groove widths of the first groove path 71, the second groove path 72, the third groove path 73, the fourth groove path 74, and the fifth groove path 75 are formed to be substantially constant, but the groove widths may be changed.

Further, as described above, no dead end is formed in the lubricating oil groove 63, and the first inlet 71a, the second inlet 72a, and the third inlet 73a communicate with any one of the first outlet 71b, the second outlet 73b, and the third outlet 75b.

As illustrated in FIG. 7B, assuming that a center position of the fourth groove path 74 in a longitudinal direction is PO, the first groove path 71, the second groove path 72, the third groove path 73, the fourth groove path 74, and the fifth groove path 75 are disposed so as to be rotationally symmetric about the position P0.

FIG. 7C is a schematic view illustrating the inner circumference F, the outer circumference G, and the inner peripheral edge 61a described above. FIG. 7C illustrates a straight line Q1a passing through the center of the width of the first A groove portion 71c, a straight line Q1b passing through the center of the width of the first B groove portion 71d, a straight line Q2 passing through the center of the width of the second groove path 72, a straight line Q3a passing through the center of the width of the third A groove portion 73c, a straight line Q3b passing through the center of the width of the third B groove portion 73d, a straight line Q4 passing through the center of the width of the fourth groove path 74, and a straight line Q5 passing through the center of the width of the fifth groove path 75.

As illustrated in FIG. 7C, the position of the straight line Q1a at the first inlet 71a is P1, and the position of the straight line Q1b at the first outlet 71b is P2. A direction from the position P1 of directions along the straight line Q1a toward an outside (a side opposite to the center O) is defined as an inflow direction V1. An acute angle of an angle formed by a tangent line L1 of the inner circumference F at the position P1 and the straight line Q1a is defined as an inflow angle β1. A direction from the position P2 of directions along the straight line Q1b toward the outside (the side opposite to the center O) is defined as an outflow direction V2. An acute angle of an angle formed by a tangent line L2 of the outer circumference G at the position P2 and the straight line Q1b is defined as an outflow angle β2. The inflow angle β1 is preferably set to 30 degrees or more and 70 degrees or less. The outflow angle β2 is preferably set to 30 degrees or more and 70 degrees or less. Assuming that an angle in a smaller direction among angles formed by the straight line Q1a and the straight line Q1b is a bending angle β3, the bending angle β3 is preferably set to 80 degrees or more and 160 degrees or less.

As illustrated in FIG. 7C, the position of the straight line Q3a at the third inlet 73a is P3, and the position of the straight line Q3b at the second outlet 73b is P4. A direction from the position P3 of directions along the straight line Q3a toward the outside (the side opposite to the center O) is defined as an inflow direction V3. An acute angle of an angle formed by a tangent line L3 of the inner circumference F at the position P3 and the straight line Q3a is defined as an inflow angle β4. A direction from the position P4 of directions along the straight line Q3b toward the outside (the side opposite to the center O) is defined as an outflow direction V4. An acute angle of an angle formed by a tangent line L4 of the outer circumference G at the position P4 and the straight line Q3b is defined as an outflow angle β5. The inflow angle β4 is preferably set to 30 degrees or more and 70 degrees or less. The outflow angle β35 is preferably set to 30 degrees or more and 70 degrees or less. Assuming that an angle in a smaller direction among angles formed by the straight line Q3a and the straight line Q3b is a bending angle β6, the bending angle β6 is preferably set to 80 degrees or more and 160 degrees or less.

### Rotation of Friction Disc 51

FIG. 7D is a view illustrating a flow of the lubricating oil when the friction disc 51 rotates in the first circumferential direction C1.

As illustrated in FIG. 7D, in the case of rotation in the first circumferential direction C1, a flow (arrow J1) along the rotational direction is generated in the first B groove portion 71d of the first groove path 71, a flow (arrow J2) along the rotational direction is generated in the second groove path 72, a flow (arrow J3) along the rotational direction is generated in the third A groove portion 73c of the third groove path 73, and a flow (arrow J4) along the rotational direction is generated in the fifth groove path 75. Further, in a state where the separator plate 52 and the friction disc 51 are separated from each other, the lubricating oil flowing into the second groove path 72 flows into the first A groove portion 71c of the first groove path 71 and then runs on the friction portion 62c (see arrow J5), and then flows into the fourth groove path 74 and further runs on the friction portion 62d (see arrow J6). By this running on, the lubricating oil and the air are stirred, the air content in the lubricating oil increases, and peeling of an oil film can be promoted.

FIG. 7E is a view illustrating a flow of the lubricating oil when the friction disc 51 rotates in the second circumferential direction C2.

As illustrated in FIG. 7E, in the case of rotation in the second circumferential direction C2, a flow (arrow K1) along the rotational direction is generated in the first A groove portion 71c of the first groove path 71, a flow (arrow K2) along the rotational direction is generated in the third B groove portion 73d of the third groove path 73, and a flow (arrow K3) along the rotational direction is generated in the fourth groove path 74. Further, in a state where the separator plate 52 and the friction disc 51 are separated from each other, the lubricating oil flowing into the second groove path 72 rises on the friction portion 62a (see arrow K4). By this running on, the lubricating oil and the air are stirred, the air content in the lubricating oil increases, and peeling of an oil film can be promoted.

### EXAMPLE

Next, Example will be described.

As Example, the effect of reducing the drag torque was confirmed using the above-described friction disc 51. A change in the drag torque with respect to the rotational speed was measured in a case where the friction disc 51 was rotated in the first circumferential direction C1 and in a case where the friction disc 51 was rotated in the second circumferential direction C2.

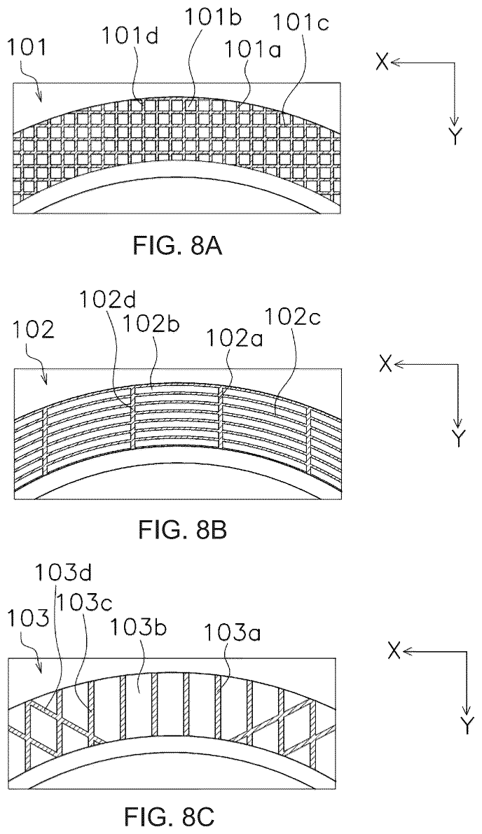

Further, as Comparative Examples 1 to 3, friction discs 101, 102, and 103 illustrated in FIG. 8(a) to 8(c) were used. In FIG. 8(a) to 8(c), groove paths 101a, 102a, and 103a are hatched. Friction portions 101b, 102b, 103b are illustrated.

As Comparative Example 1, the friction disc 101 illustrated in FIG. 8(a) was used. In the friction disc 101 illustrated in FIG. 8(a), the groove path 101a is formed to be surrounded by the plurality of friction portions 101b. In front view, the groove path 101a has a first portion 101c along a first direction X and a second portion 101d along a second direction Y. The first direction X and the second direction Y intersect at 90 degrees. A plurality of the first portions 101c is disposed side by side in the second direction Y. A plurality of the second portions 101d is disposed side by side in the first direction X.

As Comparative Example 2, the friction disc 102 illustrated in FIG. 8(b) was used. In the friction disc 102 illustrated in FIG. 8(b), the groove path 102a is formed to be surrounded by the plurality of friction portions 102b. The groove path 102a has a first portion 102c formed along the circumferential direction and a second portion 102d formed along the second direction Y. A plurality of the first portions 102c is disposed side by side along the radial direction. A plurality of the second portions 102d is disposed side by side in the first direction X perpendicular to the second direction Y.

As Comparative Example 3, the friction disc 103 illustrated in FIG. 8(c) was used. In the friction disc 103 illustrated in FIG. 8(c), the groove path 103a is formed to be surrounded by the plurality of friction portions 103b. The groove path 103a includes a first portion 103c formed along the second direction Y and a second portion 103d formed obliquely with respect to the second direction Y. A plurality of the first portions 103c is disposed side by side in the first direction X perpendicular to the second direction Y. The second portion 103d intersects with some of the first portions 103c.

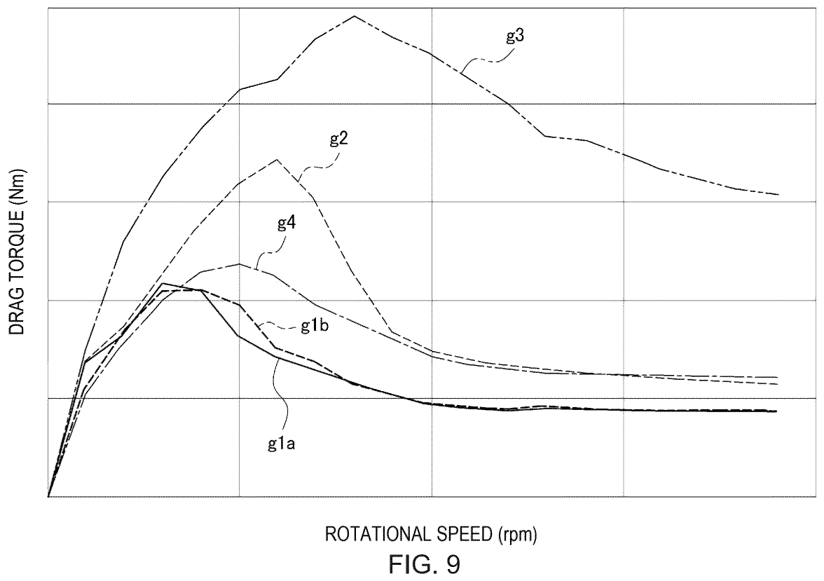

FIG. 9 is a graph illustrating a change in drag torque with respect to a rotational speed in Example and Comparative Examples 1 to 3. In FIG. 9, the horizontal axis represents the rotational speed (rpm), and the vertical axis represents the drag torque (Nm). Graph g1a in a case where the friction disc 51 of Example is rotated in the second circumferential direction C2 is indicated by the solid line, and Graph g1b in a case where the friction disc 51 is rotated in the first circumferential direction C1 is indicated by the thick dotted line. Graph g2 of Comparative Example 1 is indicated by the thin dotted line, Graph g3 of Comparative Example 2 is indicated by the two-dot chain line, and Graph g4 of Comparative Example 3 is indicated by the one-dot chain line. Note that, in the case of Comparative Examples 1 to 3, since the grooves are formed symmetrically in FIG. 8(a) to 8(c), a similar result is obtained in any rotational direction.

As illustrated in Graph of FIG. 9, it can be seen that the drag torque of the friction disc 51 of Example is reduced in the entire range of the rotational speed in both Comparative Example 1 and Comparative Example 2 in any rotation. Further, it can be seen that the drag torque of the friction disc 51 of Example slightly increases at a lower rotational speed than that of Comparative Example 3, but the drag torque is remarkably reduced when the rotational speed increases.

### Features and the Like

In the friction disc 51 of the present embodiment, the lubricating oil groove 63 through which the lubricating oil passes has the plurality of first groove paths 71 and the plurality of second groove paths 72. The plurality of first groove paths 71 is formed in the surface 51a side by side in the circumferential direction C. The plurality of second groove paths 72 is formed in the surface 51a side by side in the circumferential direction C. Each of the first groove paths 71 has the first inlet 71a, the first outlet 71b, and the first A groove portion 71c. The first inlet 71a is disposed on the inner peripheral edge 61a side, and into which the lubricating oil flows. The first outlet 71b is disposed on the outer peripheral edge 61b side, and from which the lubricating oil flows out. The first A groove portion 71c is formed from the first inlet 71a and is inclined to the first circumferential direction C1 side in the circumferential direction C with respect to the radial direction B. Each of the second groove paths 72 has the second inlet 72a disposed on the inner peripheral edge 61a side and into which the lubricating oil flows. Each of the second groove paths 72 is inclined to the second circumferential direction C2 side opposite to the first circumferential direction C1 with respect to the radial direction B and joins the first A groove portion 71c. The joining portion 76 where the second groove path 72 joins the first A groove portion 71c forms a three-way junction. The joining portion 76 is disposed closer to the first inlet 71a between the first inlet 71a and the first outlet 71b of the first groove path 71.

For example, in the case of rotation in the second circumferential direction C2, as illustrated in FIG. 7E, the first A groove portion 71c of the first groove path 71 is inclined along the rotational direction. Therefore, the lubricating oil easily flows into the first A groove portion 71c, a pressure gain can be increased, and a force for transporting a fluid can be increased. As a result, the lubricating oil can be efficiently discharged, and the drag torque can be reduced. Since the second groove path 72 is inclined along the direction opposite to the rotational direction, the lubricating oil moves over the second groove path 72 in the state where the separator plate 52 and the friction disc 51 are separated from each other. As a result, the lubricating oil and the air are stirred, the air content in the lubricating oil increases, and peeling of the oil film can be promoted.

For example, in the case of rotation in the first circumferential direction C1, the second groove path 72 is inclined along the rotational direction as illustrated in FIG. 7D. Therefore, the lubricating oil easily flows into the second groove path 72, the pressure gain can be increased, and the force for transporting a fluid can be increased. As a result, the lubricating oil can be efficiently discharged, and the drag torque can be reduced. Since the first A groove portion 71c of the first groove path 71 is inclined along the direction opposite to the rotational direction, the lubricating oil flowing into the second groove path 72 moves over the first A groove portion 71c in the state where the separator plate 52 and the friction disc 51 are separated from each other. As a result, the lubricating oil and the air are stirred, the air content in the lubricating oil increases, and peeling of the oil film can be promoted.

In the friction disc 51 of the present embodiment, the lubricating oil groove 63 through which the lubricating oil passes has the plurality of third groove paths 73 and the plurality of fourth groove paths 74. The plurality of third groove paths 73 is formed in the surface 51a side by side in the circumferential direction C. The plurality of fourth groove paths 74 is formed in the surface 51a side by side in the circumferential direction C. The third groove path 73 includes the third inlet 73a, the second outlet 73b, and the third A groove portion 73c. The third inlet 73a is disposed on the inner peripheral edge 61a side, and into which the lubricating oil flows. The second outlet 73b is disposed on the outer peripheral edge 61b side, and from which the lubricating oil flows out. The third A groove portion 73c is formed from the third inlet 73a and is inclined to the second circumferential direction C2 side in the circumferential direction C with respect to the radial direction B. Each of the fourth groove paths 74 branches from the third A groove portion 73c and is inclined to the first circumferential direction C1 side opposite to the second circumferential direction C2 with respect to the radial direction B. The branching portion 77 where the fourth groove path 74 branches from the third A groove portion 73c forms a three-way junction. The branching portion 77 is disposed closer to the third inlet 73a between the third inlet 73a and the second outlet 73b of the third groove path 73.

For example, in the case of rotation in the first circumferential direction C1, as illustrated in FIG. 7D, the third A groove portion 73c of the third groove path 73 is inclined along the rotational direction. Therefore, the lubricating oil easily flows into the third A groove portion 73c, the pressure gain can be increased, and the force for transporting a fluid can be increased. As a result, the lubricating oil can be efficiently discharged, and the drag torque can be reduced. Further, since the fourth groove path 74 is inclined along the direction opposite to the rotational direction, the lubricating oil moves over the fourth groove path 74 in the state where the separator plate 52 and the friction disc 51 are separated from each other. As a result, the lubricating oil and the air are stirred, the air content in the lubricating oil increases, and peeling of the oil film can be promoted.

For example, in the case of rotation in the second circumferential direction C2, the fourth groove path 74 is inclined along the rotational direction as illustrated in FIG. 7E. Therefore, the lubricating oil easily flows into the fourth groove path 74, the pressure gain can be increased, and the force for transporting a fluid can be increased. As a result, the lubricating oil can be efficiently discharged, and the drag torque can be reduced. Further, since the third A groove portion 73c of the third groove path 73 is inclined along the direction opposite to the rotational direction, the lubricating oil moves over the third A groove portion 73c in the state where the separator plate 52 and the friction disc 51 are separated from each other. As a result, the lubricating oil and the air are stirred, the air content in the lubricating oil increases, and peeling of the oil film can be promoted.

### Other Embodiments

Although one embodiment of the present invention has been described above, the present invention is not limited to the above embodiment, and various modifications can be made without departing from the gist of the invention. In particular, a plurality of examples and modifications described in the present specification can be arbitrarily combined as necessary.
(A)

In the above-described embodiment, each of the side walls 63a and the side walls 63b of the lubricating oil groove 63 is formed in a straight line in front view, but the embodiment is not limited thereto, and the lubricating oil groove 63 may be formed in a curved line.
(B)

In the above-described embodiment, the bottom surface of the lubricating oil groove 63 is the surface of the plate member 61.
(C)

In the above-described embodiment, the lubricating oil groove 63 is formed by laser processing, but the embodiment is not limited thereto. For example, the groove path may be formed by attaching a friction material formed in the shape of the friction portions 62a, 62b, 62c, and 62d, and 62e to the surface of the plate member 61. Furthermore, the lubricating oil groove 63 may be formed by machining such as pressing and cutting.
(D)

In the above-described embodiment, the friction disc 51 is used for the transmission 24, but the embodiment is not limited to the transmission, and the friction disc 51 can be used for any power transmission device.
(E)

In the above-described embodiment, the friction disc 51 is used for a bulldozer, but the embodiment is not particularly limited, and the friction disc 51 can be applied to an excavator, a wheel loader, a forklift, and the like.

### INDUSTRIAL APPLICABILITY

The friction disc, the multiplate clutch, the transmission, and the work machine of the present disclosure can exhibit an effect of further reducing the drag torque.

### REFERENCE SIGNS LIST

51 Friction disc
71 First groove path
71a First inlet
71b First outlet
71c First A groove portion
72 Second groove path
72a Second inlet
76 Joining portion

1. A friction disc used in a power transmission device, the friction disc comprising:
a lubricating oil groove through which lubricating oil passes, the lubricating oil groove including
a plurality of first groove paths formed in a surface side by side in a circumferential direction, and
a plurality of second groove paths formed in the surface side by side in the circumferential direction,
each of the first groove paths including
a first inlet disposed on an inner peripheral edge side and into which the lubricating oil flows,
a first outlet disposed on an outer peripheral edge side and from which the lubricating oil flows out, and
a first A groove portion formed from the first inlet and inclined to a first circumferential direction side in the circumferential direction with respect to a radial direction,
each of the second groove paths
including a second inlet that is disposed on the inner peripheral edge side and into which the lubricating oil flows,
being inclined to a second circumferential direction side opposite to the first circumferential direction with respect to the radial direction, and
joining the first A groove portion, and
a joining portion where the second groove path joins the first A groove portion forming a three-way junction, and being disposed closer to the first inlet between the first inlet and the first outlet of the first groove path.

2. A friction disc used in a power transmission device, the friction disc comprising:
a lubricating oil groove through which lubricating oil passes, the lubricating oil groove including
a plurality of third groove paths formed in a surface side by side in a circumferential direction, and
a plurality of fourth groove paths formed in the surface side by side in the circumferential direction,
each of the third groove paths including
a third inlet disposed on an inner peripheral edge side and into which the lubricating oil flows,
a second outlet disposed on an outer peripheral edge side and from which the lubricating oil flows out, and
a third A groove portion formed from the third inlet and inclined to a second circumferential direction side in the circumferential direction with respect to a radial direction,
each of the fourth groove paths
branching from the third A groove portion, and
being inclined to a first circumferential direction side opposite to the second circumferential direction with respect to the radial direction, and
a branching portion where the fourth groove path branches from the third A groove portion forming a three-way junction, and being disposed closer to the third inlet between the third inlet and the second outlet of the third groove path.

3. The friction disc according to claim 1, wherein
the first groove path further includes a first B groove portion
formed from an end of the first A groove portion on the outer peripheral edge side to the first outlet and
inclined to the second circumferential direction side with respect to the radial direction.

4. The friction disc according to claim 2, wherein
the third groove path further includes a third B groove portion
formed from an end of the third A groove portion on the outer peripheral edge side to the second outlet and
inclined to the first circumferential direction side with respect to the radial direction.

5. The friction disc according to claim 1, wherein
an outflow angle formed by a tangent line at the first outlet of a circumference passing through the first outlet and an outflow direction in which the lubricating oil flows out from the first outlet is 30 degrees or more and 70 degrees or less, and
an inflow angle formed by a tangent line of the first inlet of a circumference passing through the first inlet and an inflow direction in which the lubricating oil flows into the first inlet is 30 degrees or more and 70 degrees or less.

6. The friction disc according to claim 2, wherein
an outflow angle formed by a tangent line at the second outlet of a circumference passing through the second outlet and an outflow direction in which the lubricating oil flows out from the second outlet is 30 degrees or more and 70 degrees or less, and
an inflow angle formed by a tangent line of the third inlet of a circumference passing through the third inlet and an inflow direction in which the lubricating oil flows into the third inlet is 30 degrees or more and 70 degrees or less.

7. The friction disc according to claim 3, wherein
an angle formed by the first A groove portion and the first B groove portion is 80 degrees or more and 160 degrees or less.

8. The friction disc according to claim 4, wherein
an angle formed by the third A groove portion and the third B groove portion is 80 degrees or more and 160 degrees or less.

9. The friction disc according to claim 1, wherein
in a case where a joining portion that another groove path joins or a branching portion branching to another groove path is provided in the groove path in addition to the joining portion, any of the joining portions and the branching portion forms a three-way junction.

10. The friction disc according to claim 2, wherein,
in a case where a joining portion that another groove path joins or a branching portion branching to another groove path is provided in the groove path in addition to the branching portion, any of the joining portion and the branching portions forms a three-way junction.

11. The friction disc according to claim 9, wherein
both side walls disposed on both sides of the groove path in the circumferential direction are formed without unevenness in a portion other than the joining portion or the branching portion, and
the first inlet and the second inlet continue to the first outlet.

12. The friction disc according to claim 10, wherein
both side walls disposed on both sides of the groove path in the circumferential direction are formed without unevenness in a portion other than the joining portion or the branching portion, and
the third inlet continues to the second outlet.

13. The friction disc according to claim 1, wherein
a width of the first groove path is constant, and
a length of the width of the first groove path is 0.3% or more and 1.2% or less of a radius of the friction disc.

14. The friction disc according to claim 2, wherein
a width of the third groove path is constant, and
a length of the width of the third groove path is 0.3% or more and 1.2% or less of a radius of the friction disc.

15. The friction disc according to claim 1, wherein
the lubricating oil groove further includes
a plurality of third groove paths formed in the surface side by side in the circumferential direction, and
a plurality of fourth groove paths formed in the surface side by side in the circumferential direction,
each of the third groove paths includes
a third inlet disposed on the inner peripheral edge side and into which the lubricating oil flows,
a second outlet disposed on the outer peripheral edge side and from which the lubricating oil flows out, and
a third A groove portion formed from the third inlet and inclined to the second circumferential direction side with respect to the radial direction,
each of the fourth groove paths
branches from the third A groove portion,
is inclined in the first circumferential direction with respect to the radial direction, and
joins the first groove path, and
a branching portion where the fourth groove path branches from the third A groove portion forms a three-way junction, and is disposed closer to the third inlet between the third inlet and the second outlet of the third groove path.

16. The friction disc according to claim 15, wherein
the first groove path further includes a first B groove portion
formed from an end of the first A groove portion on the outer peripheral edge side to the first outlet and
inclined to the second circumferential direction side with respect to the radial direction,
the fourth groove path joins the first B groove portion of the first groove path,
the third groove path further includes a third B groove portion
formed from an end of the third A groove portion on the outer peripheral edge side to the second outlet and
inclined in the first circumferential direction with respect to the radial direction, and
a fifth groove path having a third outlet disposed on the outer peripheral edge side, and from which the lubricating oil flows out, branching from the third B groove portion, and inclined to the second circumferential direction side is further included.

17. The friction disc according to claim 16, wherein
the first groove path, the second groove path, the third groove path, the fourth groove path, and the fifth groove path are disposed so as to be rotationally symmetric about a center of the fourth groove path in a longitudinal direction.

18. A multiplate clutch including the friction disc according to claim 1, the multiplate clutch further comprising:
a separator plate disposed next to the friction disc, the friction discs and the separator plates being alternately disposed.

19. A transmission including the multiplate clutch according to claim 18, the transmission further comprising:
an input shaft;
an output shaft; and
a plurality of power transmission mechanisms that transmits rotation of the input shaft to the output shaft, the multiplate clutch being provided in each of the plurality of power transmission mechanisms and transmitting power or blocking transmission of power.

20. A work machine including the transmission according to claim 19, the work machine further comprising:
an engine; and
a torque converter that transmits power from the engine to the transmission,
the transmission performing switching between forward and backward movements and shifting.
